(19) United States
(12) Patent Application Publication
(10) Pub. No.: US 2016/0107891 A1
(43) Pub. Date: Apr. 21, 2016

(54) Gas Generating Apparatus

(71) Applicant: PHILTECH, Inc., Tokyo (JP)

(72) Inventors: Yuji FURUMURA, Kanagawa (JP); Noriyoshi SHIMIZU, Tokyo (JP); Shinji NISHIHARA, Tokyo (JP)

(21) Appl. No.: 14/855,493

(22) Filed: Sep. 16, 2015

(30) Foreign Application Priority Data
Oct. 16, 2014 (JP) 2014-211750

(51) Int. Cl. C01B 3/38

(52) U.S. Cl. CPC C01B 3/38; C01B 2203/0805; C01B 2203/1064; C01B 2203/1082; C01B 2203/1241

(57) ABSTRACT

To generate hydrogen having a carbon monoxide concentration of 0.1% or less by reacting a hydrogen carbide and water with each other without using a platinum catalyst. A gas generating apparatus includes a gas instantaneously-heating mechanism that instantaneously heats a source gas and a catalyst vessel that is connected to the gas instantaneously-heating mechanism and contains a catalyst, a high-temperature heated source gas beam generated by the gas instantaneously-heating mechanism being caused to collide with the catalyst to generate a gas. More specifically, a source gas containing a hydrogen carbide and water is instantaneously heated to a high temperature, and a source gas beam is caused to collide with the catalyst. Heat of the source gas is transmitted to a catalyst surface because of the absence a stagnation layer, and nonequilibrium reaction efficiently proceeds on the catalyst. Hydrogen can be extracted with a low-price catalyst made of ruthenium.

### BACKGROUND

1. Field of the Invention

The present invention relates to a gas generating apparatus that causes a heated high-temperature gas to collide with a catalyst to accelerate a reaction and generates a gas.

2. Description of Related Art

In general, a gas is caused to react on a catalyst to make it possible to generate a desired gas. For example, a vessel containing a platinum catalyst is heated, and methane and water vapor are put in the vessel. At this time, a reaction proceeds on the catalyst to generate hydrogen H₂, carbon dioxide CO₂, and carbon monoxide CO. The hydrogen generated here is used in a fuel cell to make it possible to generate electricity.

In this case, the generated gas contains about 10% of carbon monoxide. Since the carbon monoxide deteriorates electrodes of the fuel cell, the concentration of carbon monoxide need to be lowered to about 1 ppm or less. Thus, in order to reduce the carbon monoxide concentration, the carbon monoxide is caused to react with water vapor on the platinum catalyst again, and the carbon monoxide concentration decreases to 1% or less. Furthermore, the carbon monoxide is combusted on the catalyst with oxygen to make it possible to reduce the carbon monoxide concentration to about 1 ppm. However, platinum is expensive, and industries using platinum cannot be expected to grow because a cost of generating hydrogen cannot be reduced in a hydrogen generating method in which a reaction is performed on a platinum catalyst.

More specifically, if the platinum catalyst is moderately priced, no issue is posed. However, it is reported that an amount of platinum produced per year is only 200 t, and the purposes of use of platinum serving as resources are limited. Thus, it is industrially requested that a catalyst having a price lower than that of platinum, and a high reaction speed is achieved to generate hydrogen having a lower carbon monoxide with a single reaction.

In this case, as a measure of reaction speed, fabrication of an apparatus having a high reaction speed which can reduced a carbon monoxide concentration to a concentration of 0.1% or less will be considered. One of theoretical methods for performing a reaction at a high speed is a method of decreasing the thickness of a stagnation layer serving as a resistor when a source gas reaches a catalyst surface. A heat exchange device that efficiently performs heat exchange by using a principle for decreasing the thickness of the stagnation layer is known (for example, see Japanese Patent Application Nos. 2012-107128, 2012-203119, 2013-237211, and 2013-197594).

According to the principles described in Japanese Patent Application Nos. 2012-107128, 2012-203119, 2013-237211, and 2013-197594, a gas is caused to collide with a high-temperature wall at a high speed to efficiently perform heat exchange between the wall and the gas. With this collision, the stagnation layer is reduced in thickness, and a resistance of heat exchange is reduced to make it possible to increase heat exchange efficiency. In addition, a reaction speed on the catalyst surface can also be increased such that the thickness of the stagnation layer is reduced by regulating an amount of source gas which is caused to reach the catalyst.

### SUMMARY OF INVENTION

However, even though a source gas is merely caused to simply collide with a catalyst surface to reduce the thickness of the stagnation layer, the issue cannot be addressed. More specifically, in the conventional technique described above, when a large amount of source gas is applied to the catalyst surface, the temperature of the catalyst surface disadvantageously decreases.

Thus, the present invention has been made in consideration of the above issue, and has as its object to provide a gas generating apparatus that uses a low-price catalyst, heats a catalyst surface to a high temperature, causes a source gas to be applied to and to collide with the catalyst surface while maintaining the temperature, and efficiently accelerates a reaction on the catalyst surface.

The present invention provides the following items to address the above issues.

(1) One or more embodiments of the present invention provides a gas generating apparatus including a gas instantaneously-heating mechanism that instantaneously heats a source gas, and a catalyst vessel that is connected to the gas instantaneously-heating mechanism and contains a catalyst, wherein a high-temperature heated source gas beam generated by the gas instantaneously-heating mechanism is caused to collide with the catalyst to generate a gas.

(2) One or more embodiments of the present invention provides a gas generating apparatus wherein, in the gas generating apparatus according to (1), the catalyst is an aggregate of particles.

(3) One or more embodiments of the present invention provides a gas generating apparatus wherein, in the gas generating apparatus according to (1), the high-temperature heated source gas beam is split into a plurality of high-temperature heated source gas beams, and the beams are caused to collide with a surface of the catalyst and converged again to extract a generated gas.

(4) One or more embodiments of the present invention provides a gas generating apparatus wherein, in the gas generating apparatus according to (1), the catalyst is a catalyst made of ruthenium-supported alumina.

(5) One or more embodiments of the present invention provides a gas generating apparatus wherein, in the gas generating apparatus according to (1), the source gas is a combination between a hydrogen carbide such as methane and water.

(6) One or more embodiments of the present invention provides a gas generating apparatus wherein, in the gas generating apparatus according to (1), one component of the generated gas is hydrogen.

(7) One or more embodiments of the present invention provides a gas generating apparatus wherein, in the gas generating apparatus according to (1), a heating temperature of the gas instantaneously-heating mechanism ranges from 500° C. to 900° C.

According to one or more embodiments of the inventions of claim 1 to claim 3, a beam of the source gas heated to a high temperature is caused to collide with the catalyst, and, with the collision, a stagnation layer is reduced in thickness to cause a nonequilibrium reaction. For this reason, at the same time, heat of the source gas is efficiently transmitted to the catalyst surface through the thin stagnation layer, and a high surface temperature can be advantageously maintained.

According to one or more embodiments of the invention of claim 4, since high reaction efficiency can be obtained, a catalyst made of ruthenium can be used without using expensive platinum. Ruthenium/alumina is one of candidates for a low-price catalyst, and a catalyst having a lower price may be used by searching. Furthermore, since expensive platinum prevents the market of organic gas reformers from being extended, the use of the low-price apparatus according to the present invention considerably influences the growth of industry.

According to one or more embodiments of the inventions of claims 5 and 6, hydrogen containing less carbon monoxide can be advantageously directly extracted from a hydrogen carbide gas by a single reaction. More specifically, an apparatus available from the market can reduce a carbon monoxide concentration to 10% at a first stage and to 0.1% at a second stage at most by a method using a platinum catalyst. According to the present invention, hydrogen having a carbon monoxide concentration of 0.1% or less can be advantageously extracted from a hydrogen carbide without using platinum.

According to one or more embodiments of the invention of claim 7, a temperature can be advantageously arbitrarily selected from temperatures ranging from 500° C. to 900° C. More specifically, in general, the temperature needs to be changed depending on the types of organic gases to be reformed. Since the gas instantaneously-heating mechanism in this temperature range can be configured by metal components, the apparatus can be fabricated at a low cost. In the structure of a heat exchanger configured by the heat-beam cylinder, a temperature difference between a gas temperature and the temperature of a heater of a heating unit can be reduced to 100° C. or less. For this reason, unlike in a heat exchanger using another principle, the temperature of metal constituting the heat exchanger can be reduced to 1000° C. or less at which deterioration failure rarely occurs. Since the advantage can be achieved, a temperature range wider than that of another heating device can be advantageously selected.

### BRIEF DESCRIPTION OF DRAWINGS

FIG. 1 is a block diagram of a catalyst high-temperature collision gas generating mechanism.

FIG. 2 is a block diagram of a gas generating apparatus including the catalyst high-temperature collision gas generating mechanism.

FIG. 3 is a block diagram of a gas generating apparatus including a plurality of high-speed collision heated source gas beams.

### DETAILED DESCRIPTION

An embodiment of the present invention will be described below with reference to the accompanying drawings.

A gas generating apparatus according to the present invention is an apparatus that causes a source to collide with a catalyst surface while the catalyst surface is heated to enhance a reaction.

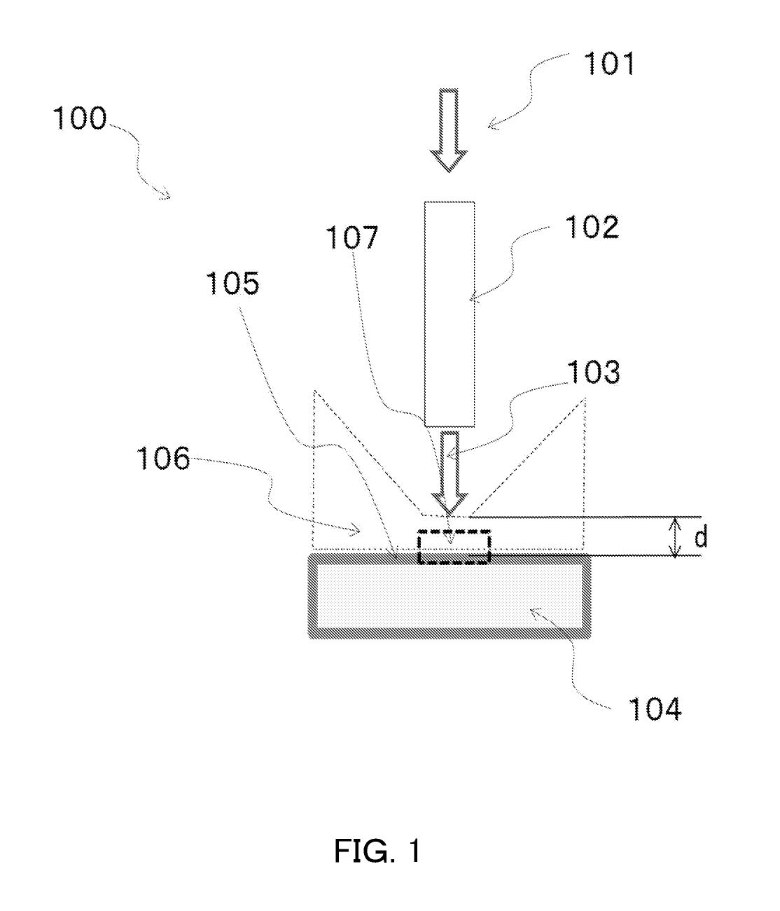

FIG. 1 shows a mechanical principle of a gas generating apparatus that causes a source instantaneously heated to collide with a catalyst surface at a high speed while the catalyst surface is heated. It is assumed that the mechanism is called a catalyst high-temperature collision gas generating mechanism 100. This mechanism 100 includes a gas instantaneously-heating mechanism 102 that instantaneously heat a source gas 101. In the heating mechanism 102, for example, the techniques disclosed in Japanese Patent Application Nos. 2012-107128, 2012-203119, 2013-237211, and 2013-197594 can be used. A gas instantaneously-heating device using the heat exchanger techniques disclosed in the patent literatures is marketed under the trade name of Heat-Beam Cylinder by Philtech Inc. (The University of Tokyo Entrepreneur Plaza 505, 7-3-1 Hongo Bunkyo-ku Tokyo 113-0033) (see the Internet <URL: http://www.philtech.co.jp/>).

Since a high-speed high-temperature gas beam 103 formed by the heating mechanism 102 has a high speed, the gas beam 103 is incident on like a beam to strongly collide with a catalyst surface 105 of a catalyst 104. With the collision of the high-temperature high-speed beam, a stagnation layer thickness d of a stagnation layer 106 at a collision portion becomes smaller than that at another portion. FIG. 1 typically shows this manner by using the stagnation layer 106 indicated by a broken line.

When the stagnation layer thickness d of the stagnation layer 106 at the collision portion decreases, a resistor layer for heat exchange decreases to cause the high-speed high-temperature gas to transmit heat to the catalyst surface 105. For this reason, the temperature of the surface becomes a temperature close to the temperature of the high-temperature source gas beam 103.

When the high-temperature source gas 103 is continuously incident on, the surface temperature is kept at a high temperature. A catalytic reaction proceeds on the catalyst surface 105 at the high temperature. In this case, since the thickness d of the stagnation layer is small, a gas generated with the reaction diffuses and moves at a speed higher than that when the thickness is large, transported by the high-current-speed high-temperature source gas beam 103, and does not flow upstream to the stagnation layer 106. More specifically, the reaction one-directionally proceeds without causing the generated gas to form a space layer for inhibiting the next reaction.

In other words, a nonequilibrium reaction proceeds in the adjacent space. Thus, a surface space with/on which the source gas collides and is incident is a high-temperature nonequilibrium reaction space 107.

In a conventional reaction scheme in which the source gas 101 is gently supplied into a catalyst vessel kept at a high temperature, since a stagnation layer also covers a catalyst surface, an equilibrium reaction occurs under diffusion control. In the equilibrium reaction, a backward reaction which decreases the reaction speed of a forward reaction occurs at once. In this embodiment, the characteristic feature of the catalyst high-temperature collision gas generating mechanism 100 is to form the nonequilibrium reaction space 107 which prevents an equilibrium reaction from occurring.

The nonequilibrium reaction makes material moving irreversibly to increase a reaction speed and to improve generating efficiency. Thus, the catalyst high-temperature collision gas generating mechanism 100 is a mechanism that causes a reaction to proceed at a high speed on the catalyst surface 105 in a nonequilibrium state.

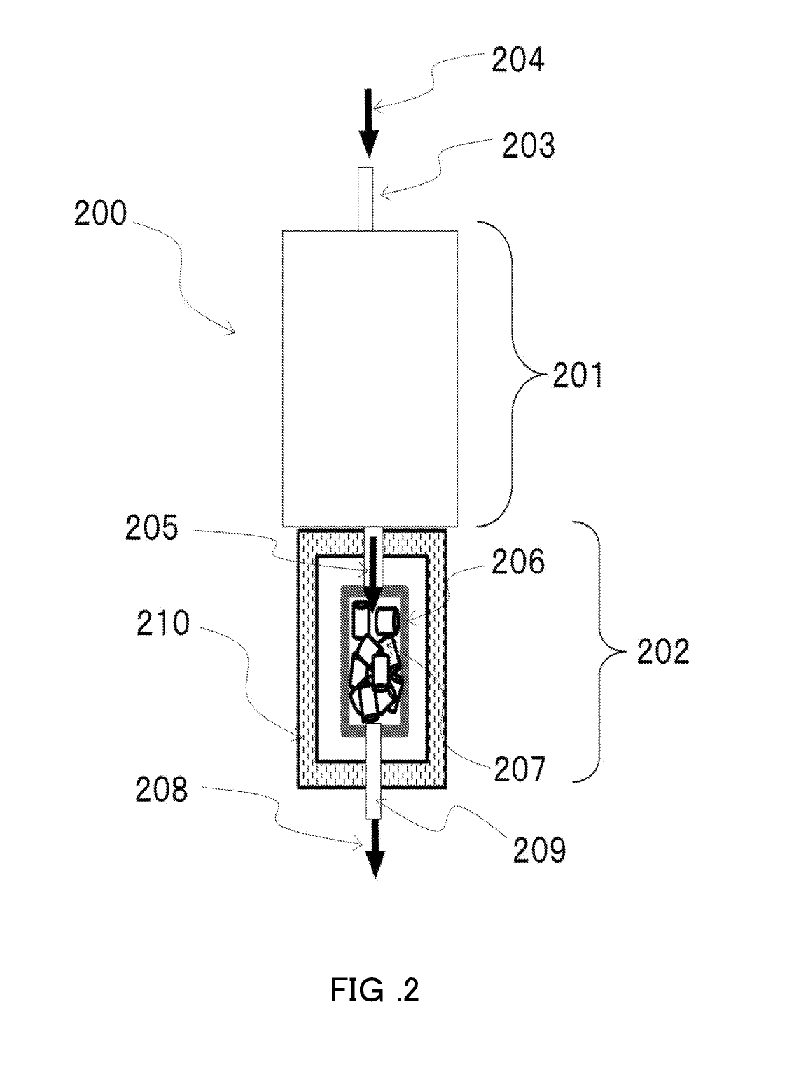

FIG. 2 shows a gas generating apparatus 200 using the mechanism 100 as a concrete structure of the apparatus. The gas generating apparatus 200 includes a gas instantaneously-heating mechanism unit 201 and a catalytic reaction unit 202 which are connected to each other.

A source gas 204 is introduced from a source gas inlet 203 at a high speed while being flow-controlled. The source gas 204 is instantaneously heated with the instantaneously-heating mechanism unit 201 to obtain a high-speed heated source gas beam 205. The heated source gas beam 205 collides with and is incident on catalyst particles 207 contained in a catalyst vessel 206. As the instantaneously-heating mechanism unit 201, a fluid heat exchanger based on the heat exchange principles described in Japanese Patent Application Nos. 2012-107128, 2012-203119, 2013-237211, and 2013-197594 is used. A gas instantaneously-heating device which employs the principles is marketed under the trade name of Heat-Beam Cylinder by Philtech Inc. (The University of Tokyo Entrepreneur Plaza 505, 7-3-1 Hongo Bunkyo-ku Tokyo 113-0033) (see the Internet <URL: http://www.philtech.co.jp/>).

The heated source gas beam 205 being incident on the surfaces of the catalyst particles 207 at a high speed reacts to generate a gas, and a generated gas 208 blows out of a generated gas outlet 209. The catalyst vessel 206 is heat-insulated by a heat-insulating mechanism 210 and kept at a constant temperature.

Methane and water are introduced as the source gas 204, and a heating set temperature of the gas instantaneously-heating mechanism unit 201 is set to, for example, 700° C. At this time, the source gas 204 reacts on the ruthenium-alumina catalyst particles 207 to generate hydrogen H2, carbon dioxide CO₂ and carbon monoxide CO as the generated gas 208.

### FIRST EXAMPLE

An example executed with the configuration shown in FIG. 2 will be described below.

A B-type Heat-Beam Cylinder available from Philtech Inc. was used as the gas instantaneously-heating mechanism unit 201. The heat-beam cylinder is a gas instantaneous heater having a maximum input power of 1500 W, and can increase the temperature up to 1000° C. As the source gas, methane and steam heated to 130° C. or higher were used. Columnar particles made of ruthenium-supported alumina were put as a catalyst in a catalyst vessel 206 which is a ⅜-inch pipe. In order to obtain a high-speed source gas beam, an argon gas was used as a carrier gas. The temperature of the source gas beam was set to 680° C. In order to cool the temperature of the generated gas, a cooling mechanism and a water collecting mechanism are connected to the generated gas outlet 209. When the components of the cooled generated gas were analyzed, the generated gas contains the rest of methane, hydrogen, carbon dioxide, and carbon monoxide, and a carbon monoxide of the generated gas except for Ar was 0.1% or less.

### SECOND EXAMPLE

The same experiment as described above was executed such that only the temperature was changed into 540° C. The measured carbon monoxide temperature was similarly 0.1% or less. As a result, an advantage of nonequilibrium reaction caused by collision was great, and hydrogen having a low carbon monoxide concentration could be obtained even with a low-price ruthenium catalyst.

As a structure that causes the heated source gas to collide with the catalyst surface, other various structures can be conceived.

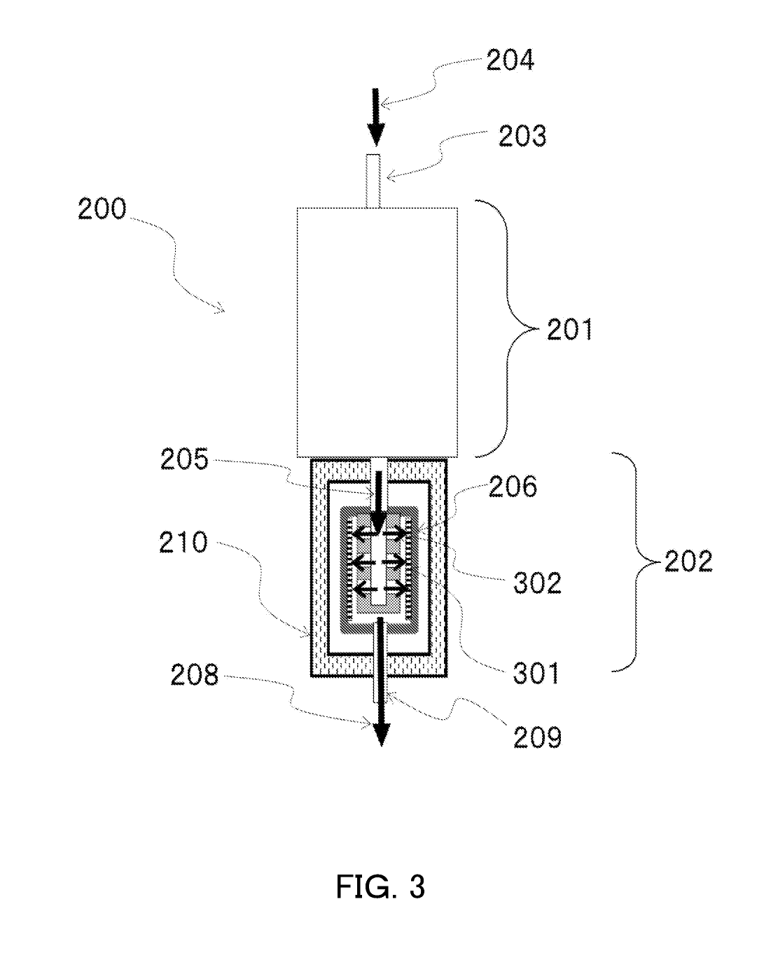

FIG. 3 shows a catalyst high-temperature collision gas generating apparatus in which the high-speed high-temperature heated source gas beam 205 are split into a plurality of high-speed high-temperature source gas beams 302, the high-temperature heated source gas beams 302 are caused to collide with the surface of a catalyst plate 301 to heat a catalyst surface, react on the surface, converged again, and extracted as the generated gas 208.

A generated gas is determined depending on a source gas. For example, when the gas contains methane and water, a heating set temperature of the gas instantaneously-heating mechanism 201 is set to 500° C. to 900° C., and the catalyst particles 207 made of ruthenium-supported alumina are used. As a result, the gas reacts to generate hydrogen H₂, carbon dioxide CO₂, and carbon monoxide CO.

A gas containing propane or other petroleum hydrogen carbides is selected and mixed with water to make it possible to generate a gas containing hydrogen.

When the gas is caused to pass through the apparatus once, a CO concentration is typically 0.1% or less. However, when the gas is caused to pass through the apparatus two or more times, the CO concentration can be more reduced.

As described above, according to the embodiment, the source gas beam heated to a high temperature collides with the catalyst, and the collision reduces a stagnation layer to cause a nonequilibrium reaction. For this reason, at the same time, heat of the source gas is also efficiently transmitted to the catalyst surface through the thin stagnation layer to make it possible to keep the surface temperature at a high temperature.

Since the reaction efficiency is high, a catalyst can be made of ruthenium without using platinum. Ruthenium/alumina is one of candidates for a low-price catalyst, and a catalyst having a lower price may be used by searching.

Hydrogen containing less carbon monoxide can be directly extracted from a hydrogen carbide gas by a single reaction. Furthermore, a temperature can be arbitrarily selected from the temperatures ranging from 500° C. to 900° C. In the structure of a heat exchanger configured by the heat-beam cylinder, a temperature difference between a gas temperature and the temperature of a heater of a heating unit can be reduced to 100° C. or less. For this reason, unlike in a heat exchanger using another principle, the temperature of metal constituting the heat exchanger can be reduced to 1000° C. or less at which deterioration failure rarely occurs.

The embodiment of the present invention has been described in detail with reference to the accompanying drawings. However, the concrete configuration of the invention is not limited to the embodiment, and includes a design or the like without departing from the spirit and scope of the invention.

### Reference Signs List

100: catalyst high-temperature collision gas generating mechanism
101: source gas
102: gas instantaneously-heating mechanism
103: high-speed high-temperature source gas beam
104: catalyst
105: catalyst surface
106: stagnation layer
107: nonequilibrium reaction space
d: stagnation layer thickness at collision portion
200: gas generating apparatus
201: gas instantaneously-heating mechanism unit
202: catalyst reaction unit
203: source gas inlet
204: source gas
205: high-speed high-temperature heated source gas beam
206: catalyst vessel
207: catalyst particle
208: generated gas
209: generated gas outlet
210: heat-insulating mechanism
301: catalyst plate
302: plurality of high-speed high-temperature heated source gas beam

What is claimed is:

1. A gas generating apparatus comprising:
a gas instantaneously-heating mechanism that instantaneously heats a source gas; and
a catalyst vessel that is connected to the gas instantaneously-heating mechanism and contains a catalyst, wherein
a high-temperature heated source gas beam generated by the gas instantaneously-heating mechanism is caused to collide with the catalyst to generate a gas.

2. The gas generating apparatus according to claim 1, wherein
the catalyst is an aggregate of particles.

3. The gas generating apparatus according to claim 1, wherein
the high-temperature heated source gas beam is split into a plurality of high-temperature heated source gas beams, and the beams are caused to collide with a surface of the catalyst and converged again to extract a generated gas.

4. The gas generating apparatus according to claim 1, wherein
the catalyst is a catalyst made of ruthenium-supported alumina.

5. The gas generating apparatus according to claim 1, wherein
the source gas is a combination between a hydrogen carbide such as methane and water.

6. The gas generating apparatus according to claim 1, wherein
one component of the generated gas is hydrogen.

7. The gas generating apparatus according to claim 1, wherein
a heating temperature of the gas instantaneously-heating mechanism ranges from 500° C. to 900° C.
